(19) United States
(12) Patent Application Publication
(10) Pub. No.: US 2007/0142994 A1
(43) Pub. Date: Jun. 21, 2007

(54) Cruise controller having a stop-and-go function, for motor vehicles

(76) Inventors: Juergen Boecker, Stuttgart (DE); Goetz Braeuchle, Reichartshausen (DE)

Correspondence Address: KENYON & KENYON LLP, ONE BROADWAY, NEW YORK, NY, 10004, US

(21) Appl. No.: 10/583,633

(22) PCT Filed: Jul. 22, 2004
(86) PCT No.: PCT/DE04/01598

§ 371 Date: Jun. 20, 2006

(30) Foreign Application Priority Data
Dec. 23, 2003 (DE) 103 60 776.5

(51) Int. Cl. B60R 22/00

(52) U.S. Cl. 701/93; 701/46

(57) ABSTRACT

A cruise controller having a stop-and-go function for motor vehicles, including a control element for activating the cruise controller, and an activation lock which prevents activation when the brake pedal is operated. The activation lock is ineffective when predefined conditions—including the condition that the speed is not greater than a specific activation speed—are met.

### FIELD OF THE INVENTION

The present invention relates to a cruise controller having a stop-and-go function for motor vehicles, including a control element for activating the cruise controller, and an activation lock that prevents activation when the brake pedal is operated.

### BACKGROUND INFORMATION

German Patent Application No. DE 199 58 520 A1 describes an example of a cruise controller which has an “ACC (Adaptive Cruise Control)” mode and a “stop-and-go” mode.

In the ACC mode, the speed of the vehicle is regulated to maintain a speed selected by the driver, provided the road ahead of the vehicle is clear and any preceding vehicles are faster or far enough away. A distance sensor, e.g., a radar sensor, enables detection of preceding vehicles and in the same lane, or any other obstacles, and allows the speed to be adjusted if necessary in such a way that the directly preceding vehicle is followed at an appropriate, safe distance. The ACC mode is designed, in general, for use when driving on highways or well-maintained country roads under fluid traffic conditions, i.e., traffic conditions that are relatively undynamic, where the distances between vehicles are relatively large.

The stop-and-go mode, on the other hand, is provided for use in the lower speed range and offers functionalities that are not available in the ACC mode, in particular the functionality of automatically decelerating the host vehicle to a standstill, e.g., when approaching the back end of a traffic jam. Automatic restart is also possible under specific conditions, according to some of the exemplary embodiments, when the preceding vehicle starts moving again. These conditions are met, for example, when the vehicle itself stood at a standstill only relatively briefly and when the target object followed up to this point, i.e., the preceding vehicle, has remained continuously in the positioning range of the distance sensor. Under other conditions, it may be advantageous, however, to merely transmit a “start” request to the driver when the preceding vehicle starts moving, and to allow the driver to make the final decision.

The operating mode is selected either automatically or with the aid of special operating elements (mode selection buttons), using which the driver is able to activate either the ACC mode or the stop-and-go mode, or deactivate either of these modes.

If the driver operates the brake pedal and thereby actively intervenes in the situation, it may be generally assumed that a situation exists which cannot be handled by the automatic functionalities of the cruise controller. For this reason, conventional cruise controllers have been designed in such a way that the regulating function is shut off automatically as soon as the driver operates the brake pedal, thereby preventing conflicts between the driver's actions and the actions carried out by the cruise controller. As a consequence, the cruise controller cannot be activated as long as the brake pedal is operated, i.e., operating the brake pedal triggers an activation lock.

### SUMMARY

A cruise controller according to an example embodiment of the present invention may have the advantage over the related art of providing the driver with greater operator comfort. This may be achieved by the fact that the activation lock, which is triggered by the brake pedal being operated, is rendered ineffective at least under specific conditions, when the vehicle is at or near a standstill. Since the driver's operation of the brake pedal in this situation will not have the function of slowing the vehicle in order to avoid a dangerous situation, and since the cruise controller—due to its stop-and-go function—is able to keep the vehicle at a standstill and triggers an automatic restart of the vehicle only when the traffic situation allows this, safety is ensured when the cruise controller is activated when the vehicle is at a standstill. In this manner, the driver is provided with greater leeway in terms of the options available to him for activating the cruise controller.

The present invention may be particularly advantageous when used in vehicles having automatic transmissions, where the vehicle brake pedal must be kept depressed when the vehicle is at a standstill, provided the gear-shift lever is not in the neutral or park position. If the cruise controller has not been activated, the driver must keep the brake pedal depressed to keep the vehicle at a standstill. By activating the cruise controller when the vehicle is at a standstill, the driver is therefore able to lift his foot off of the brake pedal, without the vehicle rolling forward. This increases the driver's comfort and prevents the occurrence of dangerous situations which result when the driver attempts to “override” the activation lock by temporarily releasing the brake pedal—to activate the cruise controller—and accepts the fact that the vehicle rolls forward temporarily.

In one example embodiment, the activation lock is lifted when the vehicle is actually at a standstill, i.e., when the speed is exactly 0. In an alternative embodiment, the activation lock is lifted when the vehicle speed does not exceed a predefined activation speed, which may be in the order of 3 km/h.

According to a further embodiment, the activation lock is not lifted until the vehicle has stood at a standstill for a certain length of time. As a result, the driver is able to deactivate the cruise controller—as he can while driving—with the aid of the brake pedal, by operating the brake pedal while the vehicle is coming to a stop, or shortly thereafter.

The stop-and-go function may be designed in such a way that it has a plurality of different stop-and-go states. If the vehicle was automatically braked to a standstill by the cruise controller, e.g., because the preceding vehicle had stopped, the system first goes into an active stop-and-go state, in which the vehicle starts moving forward again automatically without driver intervention when the preceding vehicle starts moving again. If the vehicle has been at a standstill for a longer period of time, the system goes into a “wait” state, in which the driver must take action for the vehicle to start moving again, e.g., by confirming a prompt output by the system to drive forward. In this case, the activation lock is preferably designed in such a way that the cruise controller goes into the “wait” state and not the active stop-and-go state when it is activated while the brake pedal is depressed.

If the driver operates the brake pedal under the conditions in which the activation lock is ineffective, but the cruise controller is still in the active state, there is generally no reason to automatically deactivate the cruise controller, either. In a particularly preferred embodiment, the automatic cut-off function is therefore also deactivated under the same conditions under which the activation lock is ineffective. In the case of the embodiment in which the activation lock is lifted only after the vehicle has stood at a standstill for a certain length of time, this standstill time should not be shorter than the dwell time during which the cruise controller remains in the active stop-and-go state. If the driver operates the brake pedal after this period of time, the cruise controller remains active, although it is no longer in the active stop-and-go state which permits automatic start without driver intervention. Instead, it is in the “wait” state, and the driver is merely prompted to drive forward.

The automatic shut-off function need not be fully deactivated. Instead it may be modified in such a way that the cruise controller is automatically shut off only when the driver keeps the brake pedal depressed for longer than a specified braking duration (e.g., 5 seconds), and/or when the braking force applied by the driver exceeds a specified minimum value. As such, the driver is still able to deactivate the cruise controller with the aid of the brake pedal, but the danger of the cruise controller—which automatically keeps the vehicle at a standstill—being unintentionally deactivated by the driver accidentally touching the brake pedal is prevented. If shut-off occurs in response to the braking pressure and/or the duration of braking, the driver should be notified of this, e.g., via an acoustic warning signal, so that the driver is always informed as to whether the cruise controller is active or whether the driver himself must keep the vehicle at a standstill with the aid of the brake pedal.

As an alternative, shut-off may also take place when the brake pedal is operated multiple times within a predetermined period of time (t=tₘᵢₙ−□).

### BRIEF DESCRIPTION OF THE DRAWINGS

An exemplary embodiment of the present invention is shown in the figures and is described in greater detail below.

FIG. 1 shows a block diagram of an example cruise controller and associated control and display elements.

FIG. 2 shows a diagram to explain the mode of operation of the cruise controller.

### DETAILED DESCRIPTION OF EXAMPLE EMBODIMENTS

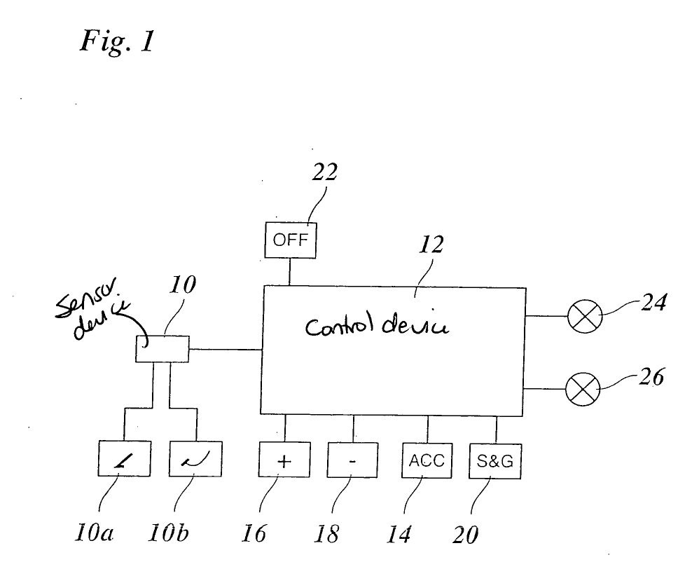

Since the design and mode of operation of a cruise controller with an ACC and stop-and-go function are generally conventional, FIG. 1 shows only the most important components in a block diagram. A sensor device 10 includes a distance sensor, e.g., a radar sensor, which measures the distance to and relative speed of a preceding vehicle. If a plurality of target objects is detected by the radar sensor, e.g., a plurality of vehicles or stationary targets such as street signs or the like, one target object is selected based on a plausibility evaluation.

Sensor device 10 also includes conventional sensors, in particular pedal sensors for an accelerator pedal 10a and brake pedal 10b, and, for example, a vehicle speed sensor, acceleration sensors to detect the longitudinal acceleration and the transverse acceleration, a yaw rate sensor and the like, which are provided in the vehicle anyway, and the signals of which are also used for other regulation purposes. The signals from the distance sensor and the remaining sensors are evaluated in an electronic control device 12, e.g., a microcomputer. Control device 12 acts on the drive and braking system of the vehicle to either regulate the vehicle speed at a speed selected by the driver or to maintain a suitable distance from the preceding vehicle.

This regulating function, referred to below as the ACC function, is activated by the driver by pressing an ACC button 14. If a desired speed was stored previously, operating the ACC button causes the regulation to this desired speed to be resumed (“resume”). Otherwise, the desired speed is set by the driver briefly pressing a button 16 once the vehicle has reached the desired speed. If button 16 is operated again or in a sustained manner, the desired speed is increased incrementally. Similarly, pressing a button 18 causes the desired speed to be reduced incrementally.

The ACC function shuts off automatically as soon as the speed of the vehicle falls below a specified value V₁ of, e.g., 40 km/h. As soon as the speed is below a larger value V₂, e.g., 50 km/h, however, the driver may activate a stop-and-go function by operating an S&G button 20. The driver will use this option, e.g., when he is approaching the back end of a traffic jam. The stop-and-go function then triggers the vehicle to automatically come to a standstill at an appropriate distance from the back end of the traffic jam. When the vehicle, stopping ahead of the host vehicle, moves forward, the stop-and-go function triggers the host vehicle to automatically start and move forward by a corresponding amount. The speed of the host vehicle is automatically limited to speed V₂ or a lower speed selected by the driver using buttons 16 and 18.

In another embodiment, the stop-and-go function may be designed in such a way that it only triggers automatic braking of the vehicle to a standstill and keeps the vehicle at a standstill, but does not enable automatic restart. Also possible is an embodiment in which the transitions between the ACC and stop-and-go functions are controlled automatically as a function of the vehicle speed.

The ACC function and stop-and-go function may be shut off using an Off button 22.

Buttons 14, 16, 18, 20 and 22 may be integrated, e.g., in a multifunction lever which is situated on the steering wheel of the vehicle, for example.

Indicator lamps 24 and 26 inform the driver of the current state of the ACC and stop-and-go functions. If indicator lamp 24 lights up in yellow, this means the ACC function is not activated, but that it may be activated under the given conditions with the aid of ACC button 14. If the color changes to green, it indicates the active status of the function. The same applies for indicator lamp 26 and the stop-and-go function.

As long as the vehicle is rolling, e.g., at a speed of at least 2 to 4 km/h, operating brake pedal 10b has the same effect as operating Off button 22, i.e., it deactivates the ACC function or stop-and-go function. As long as the driver keeps brake pedal 10b depressed, these functions may therefore not be activated with the aid of button 14 or 20 (activation lock).

When the vehicle has nearly come to a standstill, i.e., when its speed is less than or equal to a predetermined activation speed Va (in the order of 2 to 4 km/h), however, operating brake pedal 10b does not have the same function as operating Off button 22. Instead, the cruise controller, and the stop-and-go function in particular, remains active. Under these conditions it is also possible to activate the stop-and-go function with the aid of S&G button 20 while the brake pedal is depressed, if this function was previously inactive.

If the cruise controller is not active, this means—at least with a vehicle having an automatic transmission—that the driver must keep brake pedal 10b depressed in order to keep the vehicle at a standstill. If brake pedal 10b also had the effect of an activation lock while the vehicle was at a standstill, it would therefore not be possible to activate the stop-and-go function while the vehicle was at a standstill. Due to the fact that, with the cruise controller described here, the activation lock is ineffective when the speed is below the activation speed Va, the driver is able to also activate the cruise controller while the vehicle is at a standstill.

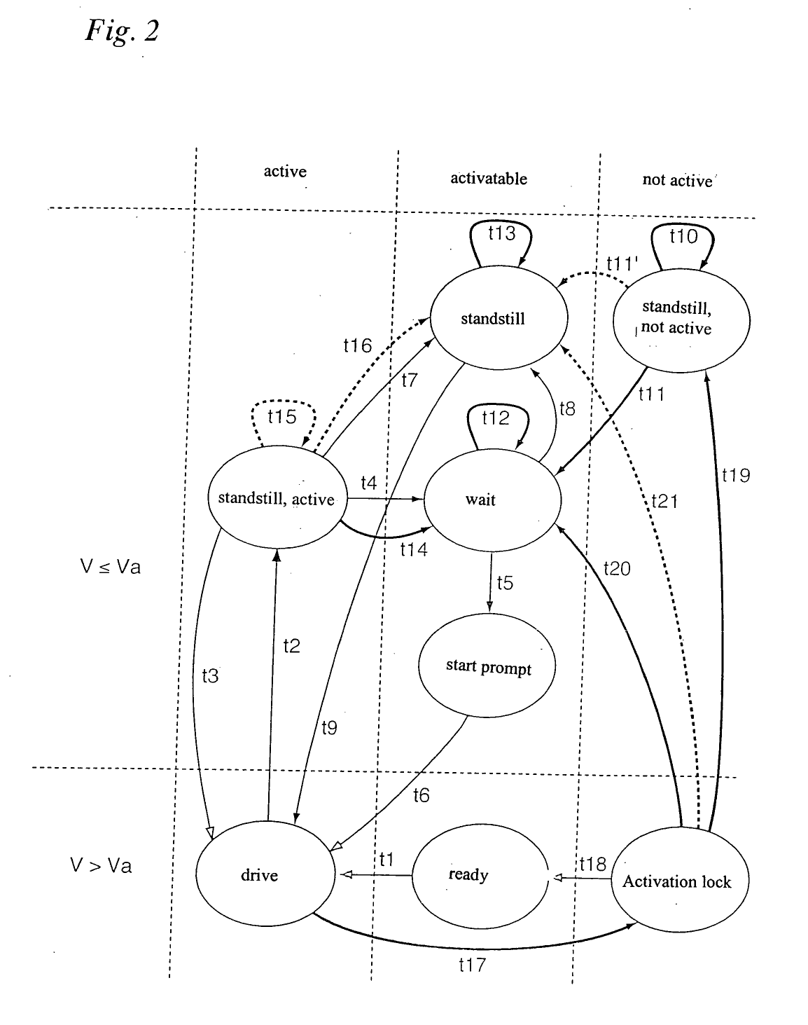

The functions of the cruise controller—to the extent they may be needed for understanding the present invention—is now described in greater detail with reference to a state diagram shown in FIG. 2. Each ellipse in FIG. 2 symbolizes a state of the cruise controller, and arrows between the individual ellipses represent transitions between the specific states. The arrows shown in bold represent transitions that are possible with brake pedal 10b depressed. Arrows with outlined, blank arrow tips represent transitions that are not possible when the brake pedal is operated. The states are arranged in a table with columns labeled “active”, “activatable” and “not active”, and rows labeled “V≦Va” and “V>Va”. For the sake of simplicity, only those states are shown which relate to the stop-and-go function. The stop-and-go function is active in the states listed in the “active” column. For states listed in the “activatable” column, the function is not active—at least not to the full extent—but it may be activated. The stop-and-go function is deactivated in the states listed in the “not active” column. States in the row labeled “V>Va” can exist only when the speed V of the vehicle is greater than activation speed Va. The states listed in the “V≦Va” row may occur when the vehicle is nearly at a standstill.

If the vehicle is traveling at a speed of, e.g., 25 km/h, and the cruise controller is not active, the state is “ready”. By operating button 20, the driver may now activate the stop-and-go function, and the system goes into the “drive” state, as indicated by arrow t1. If a target object, i.e., a preceding vehicle, exists, this vehicle will be followed at an appropriate distance. If the target object comes to a stop, the vehicle equipped with the cruise controller will be automatically braked to a standstill, as represented by a transition depicted by arrow t2 to the state “standstill, active”. In this state, the vehicle brake is automatically held by the cruise controller, so the vehicle remains at a standstill. The system remains in the state “standstill, active” for a predetermined dwell time. If the target object starts moving again within this dwell time, the host vehicle also restarts automatically, and the system goes into the “drive” state, as indicated by arrow t3.

If the dwell time has expired in the “standstill, active” state, but the target object is still there, the system goes into the “wait” state, as indicated by arrow t4. In this state, the driver must confirm before the vehicle will move forward. If the target object begins moving again, the state changes—as indicated by arrow t5—to “start prompt”, and a prompt to drive forward is output to the driver, e.g., in the form of an acoustic signal. If the driver confirms his intent to drive forward within a predetermined time interval, e.g., by operating S&G button 20 or button 16, or by pressing accelerator pedal 10a, the vehicle automatically starts, and the cruise controller goes back into the “drive” state, as indicated by arrow t6.

If, in the “standstill, active” or “wait” states, the target object becomes lost, a transition to a “standstill” state takes place, as indicated by arrows t7 and t8. The accelerator pedal (arrow t9) must be depressed to trigger a transition to the “drive” state.

If Off button 22 is operated in the “drive” state to deactivate the cruise controller, a transition occurs to the “ready” state (not represented by an arrow). If Off button 22 is operated in any of the states in which the vehicle is nearly at a standstill, a transition occurs to the “standstill, not active” state. At the same time, an acoustic signal is output to notify the driver that he must now operate the brake pedal to keep the vehicle at a standstill. Operation of the brake pedal—which itself does not cause this state to be exited—is represented by an arrow t10. Since the activation lock is not effective in this state, the driver may press S&G button 20 with the brake pedal depressed, however, to go into the “wait” state, as indicated by arrow t11. As an alternative, operating button 20 may also induce a transition to the “standstill” state (arrow t11′). The transition to the “wait” state has the advantage, however, that the driver is prompted to drive forward when the preceding vehicle moves forward. If a target object does not exist, the system returns to the “standstill” state, as indicated by arrow t8. If the brake pedal is operated in either the “wait” or “standstill” state (arrows t12 and t13), this (unlike operating Off button 22) does not induce a return to the “standstill, not active” state. Instead, the system remains in its particular state.

If the brake pedal is operated in the “standstill, wait” state, a transition preferably occurs to the “wait” state, as indicated by arrow t14. As an alternative, however, the system may remain in the “standstill, active” state (arrow t15) or it may go into the “standstill” state (arrow t16).

If the brake pedal is operated in the “drive” state, a transition occurs to the “activation lock” state, as indicated by arrow t17, and the cruise controller is deactivated. As long as the brake pedal is depressed, the stop-and-go function cannot be reactivated while driving. The state goes into the “ready” state (as indicated by arrow t18) only when the driver releases the brake pedal, and the cruise controller may be reactivated in this state.

If the driver keeps the brake pedal depressed in the “activation lock” state, the speed finally drops below Va, and, if the driver takes no further action, a transition occurs to the “standstill, not active” state, as represented by arrow t19. Once the speed has dropped below the value Va, the driver may press S&G button 20—while depressing the brake pedal—and thereby trigger the system to immediately go into the “wait” state (arrow t20) or, as a possible alternative, to the “standstill” state (arrow t21).

Possible modifications of the exemplary embodiment described above is presented briefly below with reference to FIG. 2.

Activation speed Va may also have the value 0. In this case, the activation lock and shut-off function of the brake pedal are effective only when the vehicle is actually at a standstill.

According to a further modification, the activation lock and the shut-off function of the brake pedal remain effective for a specified delay time after the system has gone into the “standstill, active” state (as shown by arrow t2), and the vehicle has come to a standstill. This delay time is preferably as long as the dwell time during which the system remains in the “standstill, active” state.

As a result, transitions t15 and t16 are not possible and, instead, when the brake pedal is operated, a transition would occur from the “standstill, active” state to the “standstill, not active” state (shut-off function of the brake pedal). The shut-off function becomes ineffective only when the brake pedal is operated, after the system has gone into the “wait” state (as indicated by arrow t4), and the system remains in the “wait” state, as indicated by arrow t12.

Another result of the delayed lifting of the shut-off function and the activation lock is that the only possible transition out of the “activation lock” state is the transition to the “standstill, not active” state, as indicated by arrow t19, and not a direct transition to the “wait” state, as indicated by arrow t20. The transition from the “standstill, not active” state into the “wait” state as indicated by arrow t11 is also possible in this case only when the vehicle has stood at a standstill for a length of time corresponding to the delay time.

In the embodiments described, operating brake pedal 10b while in the “wait” and “standstill” states and, possibly, in the “standstill, active” state, does not have the same function as operating Off button 20, i.e., it does not result in deactivation of the cruise controller. As an alternative, the cruise controller may be modified in such a way that, in the states in which the speed is less than or equal to Va, the duration of operation of the brake pedal is measured and the cruise controller is deactivated when the duration of the operation exceeds a specified threshold. As long as the brake pedal is kept depressed, the activation lock remains effective. As an alternative, the condition for deactivation of the cruise controller and for the activation lock to become effective may be that the operation force or pedal travel of the brake pedal exceeds a specified threshold value. Suitable combinations of these conditions are also feasible.

1-6. (canceled)

7. A cruise controller having a stop-and-go function for a motor vehicle, comprising:
a control element configured to activate the cruise controller; and
an activation lock which prevents activation when a brake pedal is operated, wherein the activation lock is ineffective when a predefined condition is met, the predefined condition including a condition that a speed is not greater than a specific activation speed.

8. The cruise controller as recited in claim 7, wherein the activation speed is equal to 0.

9. The cruise controller as recited in claim 8, wherein a further condition under which the activation lock is ineffective is that a predefined time interval has passed since the vehicle has been at a standstill.

10. The cruise controller as recited in claim 7, wherein the activation speed is greater than 0 but less than 10 km/h.

11. The cruise controller as recited in claim 7, wherein the cruise controller has a functionality for an automatic cut-off cruise controller when the brake pedal is operated, the automatic cut-off being effective only when the speed is greater than the activation speed.

12. The cruise controller as recited in claim 7, wherein the cruise controller has a stop-and-go function having a “standstill, active” state, in which the vehicle can be started automatically without driver intervention, and at least one “wait” state, in which the vehicle can be restarted only with driver intervention, and wherein the cruise controller, when the predefined condition is met, at least one of: i) goes into the active state when the brake pedal is operated, and ii) goes into the “wait” state when activated and the brake pedal is operated.
